(19) United States
(12) Patent Application Publication
(10) Pub. No.: US 2003/0107477 A1
(43) Pub. Date: Jun. 12, 2003

(54) Method and device for transposing a bi-directional so data stream for transmission via a low-voltage network

(76) Inventors: Hans-Dieter Ide, Dortmund (DE); Ralf Neuhaus, Lunen (DE); Joerg Stolle, Mulheim (DE)

Correspondence Address: BELL, BOYD & LLOYD, LLC, P. O. BOX 1135, CHICAGO, IL, 60690-1135, US

(21) Appl. No.: 10/169,469

(22) PCT Filed: Dec. 19, 2000
(86) PCT No.: PCT/DE00/04546

(30) Foreign Application Priority Data
Dec. 30, 1999 (DE) 19963800.4

(51) Int. Cl. H04M 11/04

(52) U.S. Cl. 340/310.01

(57) ABSTRACT

The pseudo-ternary S₀ data stream consisting of a sequence of S₀ frames (SR) is transposed into a binary data stream consisting of a sequence of binary frames (BR). The binary frames (BR) are subsequently inserted by a protocol unit (PE) into a transmission packet which is provided for transmission via the low-voltage network (NSN) and is configured according to the time division duplex method and the time division multiple access method. Said binary frames are then forwarded to a transmission unit (UEE), in order to be transmitted via the low-voltage network (NSN).

The strong development in the telecommunications market in recent years has resulted in the search for previously unused transmission capacities becoming more important, and attempts being made to make use of existing transmission capacities more efficiently. One known data transmission method is the transmission of data via the power supply network, which is frequency referred to in the literature as “Powerline Communication” or by “PLC”, for short. One advantage of using the power supply network as a medium for data transmission is that the network infrastructure already exists. Virtually every building thus has not only access to the power supply network but also to an existing, widely distributed in-house power network.

In Europe, the power supply network is subdivided into various network structures or transmission levels, depending on the type of power transmission. The high-voltage level, with a voltage range from 110 kV to 380 kV, is used for long-distance power transmission. The medium-voltage level with a voltage range from 10 kV to 38 kV is used to pass the electrical power from the high-voltage network to the area of the consumers, and is reduced by means of suitable network transformers to a low-voltage level, with a voltage range up to 0.4 kV, for the consumers. The low-voltage level is in turn subdivided into a so-called outdoor area—also referred to as the “last mile” or “access area”—and into a so-called in-house area—also referred to as the “last meter”. The outdoor area of the low-voltage level defines the region of the power supply network between the mains transformer and a meter unit which is associated with each consumer. The in-house area of the low-voltage level defines the area from the meter unit to the access units for the consumer.

In Europe, the Standard EN 50065 defines four different frequency bands—frequently referred to as CENELEC Bands A to D in the literature—with a permissible frequency range from 9 kHz to 148.5 kHz, and each having a maximum permissible transmission power, for data transmission via the power supply network, with these frequencies being reserved solely for data transmission on the basis of power line communication. However, data transmission rates of only a few tens of kilobits per second can be achieved in this case due to the restricted transmission power and the narrow bandwidth which is available in this frequency range.

However, data transmission rates in the region of several megabits per second are generally required for telecommunications applications, such as the transmission of speech data. A sufficiently wide transmission bandwidth is required, above all, to provide such a data transmission rate, and this is dependent on a frequency spectrum of up to 20 MHz, with a suitable transmission response. At the moment, data transmission in the frequency range up to 20 MHz with a suitable transmission response can be achieved solely in the low-voltage level of the power supply network.

The European patent specification EP 913955 A2 discloses a transmission network for use in electrical transmission or distribution networks. An associated filter unit allows frequency conversion of a signal to be transmitted and/or of a received signal, and matching of an associated signal level. An associated communication arrangement operates in accordance with a wire-free telephony standard at a relatively high carrier frequency, in which case payload information for the communication arrangement can be transmitted via the electrical transmission or distribution network. The frequency conversion is preferably carried out from a high frequency band to a relatively low frequency band. The communication arrangement preferably operates in accordance with the CT2 standard, which specifies wire-free transmission and reception operation in a frequency band about the mid-frequency of 866 MHz.

The document Hensen, C.: ISDN-SO-Bus Extension by Power-Line CDMA Technique, in: Proceedings of the 3rd International Symposium on Power-Line Communications and its Applications discloses transmission on an So bus in an in-house low-voltage network. This provides a multi-user environment by means of a CDMA access method (Code Division Multiple Access). CDMA is an access method which allows a number of communication terminals or data stations to have access to a common transmission channel. In this method, a number of communication terminals which share a common transmission channel use an identical frequency band, with the payload signal being coded individually for each communication terminal. The coding is based on spreading of a transmission channel associated with payload information (“payload channel”). In the described method, this coding is carried out by respectively multiplying the payload signal by a pseudo-random noise signal code.

The transmission of digital speech data additionally results in stringent bandwidth requirements with respect to the real time capability and the maximum permissible bit error rate—BER for short—in the data transmission system. In addition, the transmission of digital speech data is dependent on collision-free point-to-multipoint data transmission using a full duplex mode, that is to say error-free, simultaneous data transmission in both transmission directions between a number of subscribers. One known data transmission method for transmission of digital speech data is the ISDN transmission method (Integrated Services Digital Network). Data transmission in accordance with the ISDN transmission method, which satisfies the abovementioned conditions, may be carried out, for example, on the basis of the known S₀ interface —which is frequently also referred to as a basic access in the literature.

The present invention is based on the object of providing measures by means of which an S₀ interface can be converted for data transmission on the basis of power line communication.

According to the invention, this object is achieved by the features of patent claims 1 and 10.

One major advantage of the method according to the invention and of the apparatus according to the invention, respectively, is that conversion of the known S₀ interface for data transmission on the basis of power line communication allows conventional ISDN communications terminals to be used in a simple and cost-effective manner for data transmission via a low-voltage power network.

Advantageous developments of the invention are specified in the dependent claims.

One advantage of the refinements of the invention which are defined in the dependent claims is, inter alia, that the existing tree structure of the low-voltage power network in the in-house area can easily be mapped onto a master-slave communication relationship between a meter unit, which is configured as a master device and is in each case associated with one consumer, and the devices which are connected to the low-voltage power network and are configured as slave devices.

A further advantage of refinements of the invention which are defined in the dependent claims is that the use of the transmission mechanisms implemented for the S₀ interface allows bidirectional and collision-free data transmission via the low-voltage power network, with a maximum of up to eight connected slave devices, without any additional implementation complexity.

One exemplary embodiment of the invention will be explained in more detail in the following text with reference to the drawing, in which:

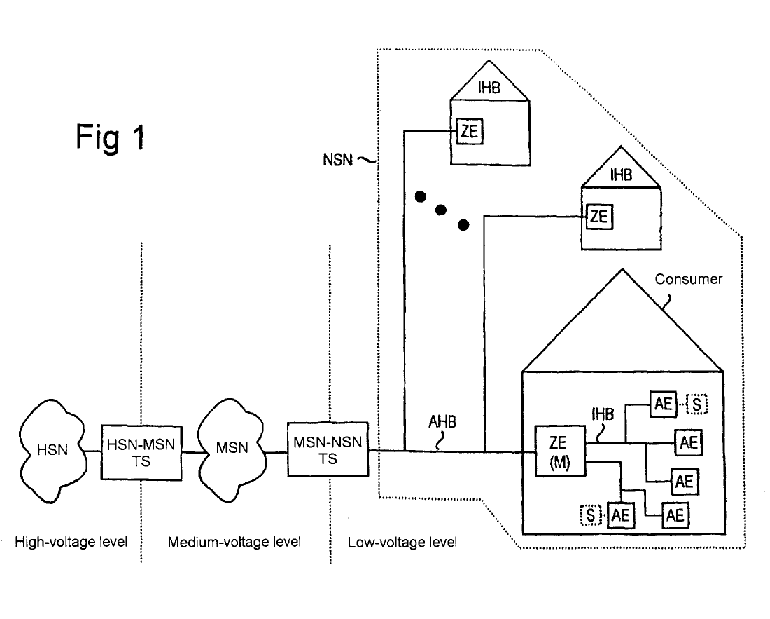

FIG. 1 shows a structogram for schematic illustration of a power supply network;

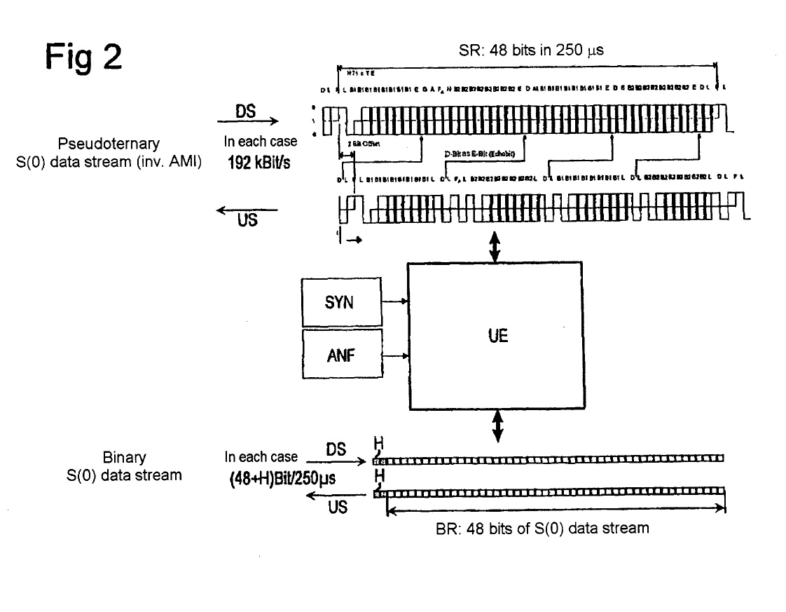

FIG. 2 shows a structogram for schematic illustration of the conversion of an S₀ data stream, which is coded using an inverted AMI channel code, to a binary-coded S₀ data stream;

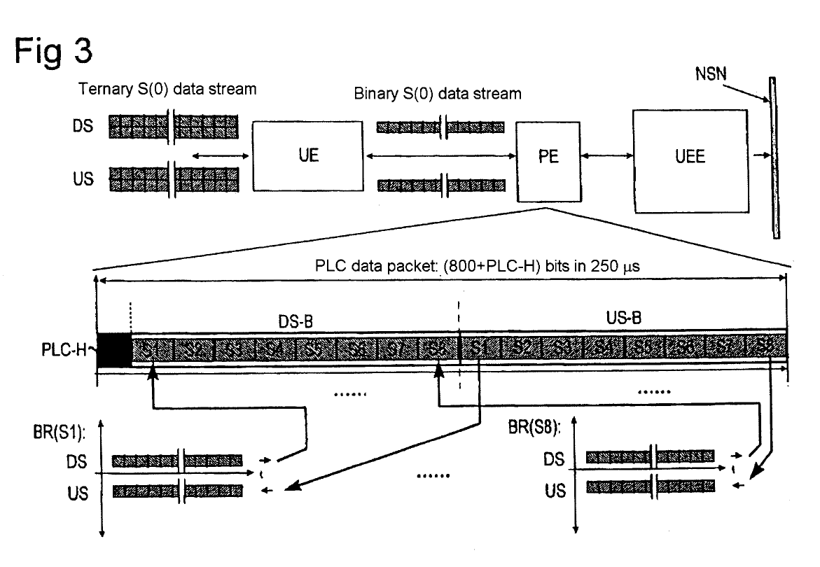

FIG. 3 shows a structogram for schematic illustration of the conversion of the S₀ data stream for transmission via a low-voltage network, according to a first conversion mode,

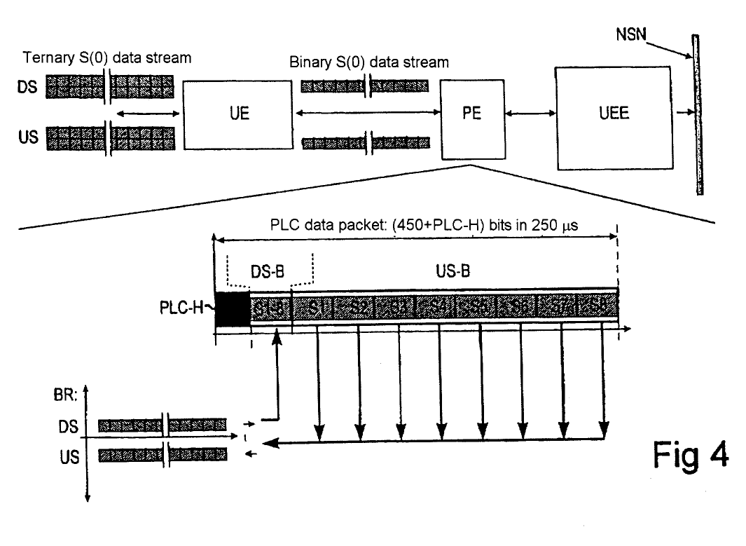

FIG. 4 shows a structogram for schematic illustration of the conversion of the S₀ data stream for transmission via a low-voltage network, according to a second conversion mode.

FIG. 1 shows a structogram with a schematic illustration of a power supply network. The power supply network is subdivided into various network structures and/or transmission levels, depending on the type of power transmission. The high-voltage level or the high-voltage network HSN with a voltage range from 110 kV to 380 kV is used to transmit power over long distances. The medium-voltage level or the medium-voltage network MSN with a voltage range from 10 kV to 38 kV is used to carry the electrical power from the high-voltage network to the vicinity of the consumers. The medium-voltage network MSN is in this case connected to the high-voltage network HSN via a transformer station HSN-MSN TS, which converts the respective voltages. The medium-voltage network MSN is also connected via a further transformer station MSN-NSN TS to the low-voltage network NSN.

The low-voltage level or the low-voltage network with a voltage range up to 0.4 kV is subdivided into a so-called outdoor area AHB and into a so-called in-house area IHB. The outdoor area AHB defines the area of the low-voltage network NSN between the further transformer station MSN-NSN TS and a meter unit ZE associated with each respective consumer. The outdoor area AHB connects a number of in-house areas IHB to the further transformer station MSN-NSN TS, which provides the conversion to the medium-voltage network MSN. The in-house area IHB defines the area from the meter unit ZE to access units AE which are arranged in the in-house area IHB. An access unit AE is, for example, a plug socket connected to the low-voltage network NSN. The low-voltage network NSN in the in-house area IHB is in this case generally designed in the form of a tree network structure, with the meter unit ZE forming the root of the tree network structure.

A transmission bandwidth of several megabits per second with a suitable transmission response is required for the transmission of digital speech data—in particular based on the S₀ interface—via the power supply network. At the moment this can be achieved only in the low-voltage network NSN. The S₀ interface uses a standard line code in the form of a so-called “inverted AMI channel” (Alternate Mark Inversion), which is converted to a binary code for conversion of the So interface for data transmission via the low-voltage network NSN.

FIG. 2 shows a structogram to schematically illustrate the conversion of an S₀ data stream, which is coded using the inverted AMT channel code, to a binary-coded S₀ data stream. An S₀ data stream in this case comprises a sequence of so-called S₀ frames SR, which can be transmitted successively. The AMI channel code is a pseudoternary line code, in which the two binary states “0” and “1” are represented by the three signal potentials ‘0’, ‘1’ and ‘−1’. In this case, in the inverted AMI channel code, the binary state “1” is represented by the signal potential ‘0’. The binary state “0” is associated either a positive or a negative signal potential ‘1’ or ‘−1’, with the polarity changing between two successive “0” states.

An S₀ interface essentially comprises two payload data channels, which are each in the form of ISDN-oriented B channels with a transmission bit rate of 64 kilobits per second each, and a signaling channel, which is in the form of an ISDN-oriented D channel with a transmission bit rate of 16 kilobits per second. Four-wire transmission is generally provided for bidirectional data transmission via the S₀ interface, with the two transmission directions—referred to as the downstream direction DS and the upstream direction US in the following text—being passed via separate lines. The downstream direction DS in this case defines the data transmission via a transmission path from a central device—referred to as the “master” M in the following text—which controls the transmission, to further devices—referred to as “slaves” S in the following text —which are connected to the transmission path. The upstream direction US defines the data transmission from the respective slaves S to the master M. In the present exemplary embodiment, the associated meter unit ZE in an in-house area IHB is configured as the master M—indicated by the M in brackets in FIG. 1—and communication devices which are connected via the access units AE to the low-voltage network NSN in the in-house area IHB are configured as slaves S. The master M can address a maximum of up to eight different slaves S via the S₀ interface. The figure in each case shows an S₀ frame SR in the downstream direction DS and in the upstream direction US for a pseudoternary S₀ data stream which is coded using the inverted AMI channel code. An S₀ frame SR has a frame length of 250 μs, and comprises a total of 48 bits. 16 bits of payload information are transmitted via a first payload data channel B1, and 16 bits of payload information are transmitted via a second payload data channel B2, with 4 bits of signaling information being transmitted via the signaling channel, in the course of each S₀ frame SR. Furthermore, additional control bits are transmitted, for example for access control, for synchronization of the downstream data stream DS and of the upstream data stream US, and in order to provide higher-level system services in accordance with the OSI layer model. This therefore results in a transmission bit rate of 192 kilobits per second in each case, both for the downstream data stream DS and for the upstream data stream US. The conditions for data transmission via the S₀ interface are standardized in the ITU-T (International Telecommunication Union) Specification I.430 “ISDN User Network Interfaces”.

The pseudoternary S₀ data stream which is coded using the inverted AMI channel code, is converted by a conversion unit UE to a binary S₀ data stream. In this case, the information, which comprises 48 bits coded using the AMI channel code, in the S₀ frame SR is converted for the downstream data stream DS and for the upstream data stream US to binary-coded information which comprises 48 bits, and is combined by means of a header H with a length of 2 bits to form a binary frame BR with a length of 50 bits. The header H comprises a synchronization bit SYN and an initial state bit ANF. The initial state bit ANF includes information about the signal potential which is associated with the first “0” state in the AMI channel code. Since the signal potential for the “0” state may have the potential “1” or “−1”, this information is necessary to allow the original AMI channel code to be reproduced at the receiver end. The synchronization bit SYN is used for synchronization of the mutually associated S₀ frames SR which are reproduced from the binary frames BR at the receiver end, for the downstream data stream DS and for the upstream data stream US, since the mutually associated S₀ frames SR of the downstream data stream DS and for the upstream data stream US are offset by two bits with respect to one another—as can be seen from the figure.

This thus in each case results in a transmission bit rate of

(48+2) bits/250 μs=200 kbit/s

for the binary S₀ data stream both for the downstream data stream DS and for the upstream data stream US.

FIG. 3 shows a structogram to schematically illustrate the conversion of the pseudoternary S₀ data stream, which is coded using the inverted AMI channel code, for transmission via the low-voltage network NSN according to a first conversion mode. In a first step, the pseudoternary S₀ data stream, which is coded using the inverted AMI channel code, is converted by the conversion unit UE—as described with reference to FIG. 2—to a binary-coded S₀ data stream. The binary-coded S₀ data stream is then passed to a protocol unit PE by means of which the binary-coded S₀ data stream is converted to a data format which is intended for data transmission via the low-voltage network NSN.

A master-slave communication relationship is set up on the basis of the tree structure which exists in the in-house area IHB of the low-voltage network NSN, for data transmission between the devices which are connected to the low-voltage network NSN in the in-house area IHB. In this case, the meter unit ZE which is arranged in the in-house area IHB and forms the root of the tree structure is defined as the master M, and the further devices which are connected via the access units AE to the low-voltage network NSN are defined as slaves S.

So-called PLC data packets with a length of 250 μs each are provided for data transmission via the low-voltage network NSN, and are subdivided into a PLC header PLC-H and a payload data area. The PLC header PLC-H essentially comprises address information for addressing the slaves S which are connected to the low-voltage network NSN. The address information may in this case be formed by an MAC address (Medium Access Control), which is in each case uniquely associated with each of the slaves S. The MAC address is a unique hardware address, which resides in layer 2 of the OSI reference model and has a length of 6 bytes. Alternatively, the slaves S which are connected to the low-voltage network NSN may be addressed by means of VPI/VCI addressing (Virtual Path Identifier/Virtual Channel Identifier), which is based on the ATM protocol (Asynchronous Transfer Mode).

In order to allow bidirectional data transmission via the low-voltage power system NSN, the payload data area of the PLC data packet is subdivided by means of the time division duplexing method—also referred to as time division duplex or ‘TDD’ for short in the literature—into two frames also referred to as duplex areas in the literature. In the process, the payload data area is subdivided into a downstream region DS-B and into an upstream region US-B. The binary frames BR, which arrive essentially at the same time—with a relative shift of two bits—in the downstream data stream DS and the upstream data stream US of the binary-coded S_{A} data stream are in this case inserted successively in time into the respective downstream region DS-B or upstream region US-B of the payload data area of the PLC data packet.

In order to ensure collision-free data transmission via the low-voltage network NSN, the downstream area DS-B and the upstream area US-B of the payload data area of the PLC data packet are subdivided by means of multiple access control methods based on time division multiplexing—also referred to in the literature as Time Division Multiple Access or “TDMA” for short—into a number of channels—frequently also referred to as time slots. The number of channels for each duplex area in this case corresponds to the maximum number of slaves S which can be connected to the low-voltage network NSN. As already described, up to a maximum of eight different slaves S1-S8 may be addressed via the S₀ interface by the master M, so that the duplex areas in the present exemplary embodiment are each subdivided into eight channels, each having a length of 50 bits. The respective subdivision of the duplex areas of the PLC data packets into the same number of channels is referred to in the literature as symmetrical frame formation.

Each slave S1-S8 is allocated one channel for each duplex area, on a permanent basis, in which channel the slave S1-S8 may send and receive, that is to say the binary frames BR associated with the slaves S1-S8 are inserted into the respective channel of the respective duplex area associated with that slave S1-S8, and are removed from it, by the protocol unit PE. The present master-slave communication relationship provides, by way of example, a cyclically fixed, hierarchical transmission sequence for each duplex area. This transmission sequence is normally referred to in the literature as “polling”, and can be achieved well by means of the TMDA method.

The PLC data packets are then transmitted from the protocol unit PE to a transmission unit UEE for transmission via the low-voltage network NSN. The transmission unit UEE provides the data transmission, by way of example, based on the OFDM transmission method (Orthogonal Frequency Division Multiplex) with upstream FEC error correction (Forward Error Correction) and upstream DQPSK modulation (Different Quadrature Phase Shift Keying). More detailed information relating to these transmission and modulation methods can be found in the diploma thesis, which has not yet been published, by Jörg Stolle: “Powerline Communication PLC”, May 1999, Siemens AG.

In this first conversion mode, the payload data area of the PLC data packet is subdivided into a total of sixteen channels, each with a length of 50 bits. This means that a relatively high transmission bit rate of:

(16×50 bit)/250 μs=3200 kbit/s

is required—ignoring the PLC header.

FIG. 4 shows a structogram in order to schematically illustrate conversion of the pseudoternary S₀ data stream, which is coded using the inverted AMI channel code, for transmission via the low-voltage power system NSN using a second conversion mode. Analogously to the first conversion mode, the pseudoternary S₀ data stream coded using the inverted AMI channel code is converted in a first step by means of the conversion unit UE—as described with reference to FIG. 2—to a binary-coded S₀ data stream. The binary-coded S₀ data stream is then passed to a protocol unit PE, by means of which the binary-coded S₀ data stream is converted to a data format which is intended for data transmission via the low-voltage network NSN.

In contrast to the first conversion mode in which frames are formed symmetrically, asymmetric frame formation is used for the second conversion mode. Analogously to the first conversion mode, the payload data area of the PLC data packet is subdivided by means of the time division duplexing method into a downstream area DS-B and into an upstream area US-B. Furthermore, in order to ensure that data is transmitted without collision via the low-voltage network NSN, the upstream area US-B of the payload data area of the PLC data packet is subdivided by means of the time division multiplex-based multiple access control method into eight channels, each with a length of 50 bit. Each slave S1-S8 is permanently allocated one channel in the upstream area US-B, in that it may transmit, that is to say the binary frames BR which are associated with the slaves S1-S8 are inserted by the protocol unit PE into the respective channel which is associated with the slave S1-S8, in the upstream area US-B. With the present master/slave communication relationship, the transmission sequence is carried out analogously to the first conversion mode, using polling.

The downstream area DS-B in the second conversion mode has only a single channel with a length of 50 bits, via which data is transmitted from the master M to the slaves S1-S8. Since the master M is the only device which transmits in the downstream direction DS, there is no need for the point-to-multipoint structure that is used in the first conversion mode. In the second conversion mode, the payload information to be transmitted is transmitted in parallel to all the slaves S1-S8. This transmission method is generally referred to as the “broadcasting mode”. The transmission bit rate required for data transmission via the low-voltage network NSN in the downstream direction DS can be reduced in this way.

The PLC data packets are then transferred from the protocol unit PE to a transmission unit UEE for transmission via the low-voltage network NSN. The transmission unit UEE carries out the data transmission analogously to the first conversion mode based on the OFDM transmission method, with upstream FEC error correction and upstream DQPSK modulation.

Thus, for the second conversion mode—ignoring the PLC header—this results in a transmission bit rate, which is lower than that required for the first conversion mode, of:

(9×50 bit)/250 μs=1800 kbit/s.

At the receiver end, the PLC data packets are read from the low-voltage network NSN and are converted to a pseudoternary S₀ data stream, which is coded using the inverted AMI channel code, analogously to the described method of operation, but in the opposite direction.

1. A method for conversion of a bidirectional S₀ data stream for transmission via a low-voltage power network (NSN),
in which the pseudoternary S₀ data stream, comprising a sequence of S₀ frames (SR), is converted to a binary data stream comprising a sequence of binary frames (BR), in which method a transmission packet which is intended for data transmission via the low-voltage power network (NSN) is subdivided using a time division duplexing method (Time division Duplex TDD), into a first area (DS-B) for data transmission in a first transmission direction (DS) and into a second area (US-B) for data transmission in a second transmission direction (US), and
in which method the binary frames (BR) are inserted into the first or into the second area (DS-B, US-B) of the transmission packet depending on the direction, and are passed to a transmission unit (UEE) for transmission via the low-voltage power network (NSN).

2. The method as claimed in claim 1,
characterized
in that a master-slave communication relationship is set up for data transmission via the low-voltage power network (NSN).

3. The method as claimed in claim 2,
characterized
in that binary frames (BR) are transmitted in the first area (DS-B) from a master device (M) to at least one slave device (S1-S8), and binary frames (BR) are transmitted in the second area (US-B) from the at least one slave device (S1-S8) to the master device (M).

4. The method as claimed in claim 3,
characterized
in that the master device (M) allocates transmission and reception rights for the slave devices (S1-S8) using a polling method.

5. The method as claimed in one of the preceding claims,
characterized
in that the first area (DS-B) and the second area (US-B) of the transmission packet are each subdivided into at least one subframe by means of a multiple access control method based on time division multiplexing (time division multiple access TDMA),
and in that the binary frames (BR) are each inserted into a subframe in the first area (DS-B) or in the second area (US-B) of the transmission packet depending on the direction.

6. The method as claimed in claim 5,
characterized
in that the first area (DS-B) and the second area (US-B) are each subdivided into eight subframes, with each slave device (S1-S8) which is connected to the low-voltage power network (NSN) in each case being assigned one subframe in the first area (DS-B) and one subframe in the second area (US-B), on a permanent basis, for bidirectional data transmission with the master device (M).

7. The method as claimed in claim 5,
characterized
in that the first area (DS-B) is subdivided into an individual subframe, and the second area (US-B) is subdivided into eight subframes, with each slave device (S1-S8) which is connected to the low-voltage power network (NSN) in each case being assigned one subframe in the second area (US-B), on a permanent basis, for data transmission to the master device (M), and data being transmitted from the master device (M) to the slave devices (S1-S8) jointly via the subframes of the first area (DS-B).

8. The method as claimed in one of the preceding claims,
characterized
in that, during conversion of an S₀ frame (SR) to a binary frame (BR), information is added to the binary frame (BR) for recovery of the S₀ frame (SR).

9. The method as claimed in claim 8,
characterized
in that an initial state bit (ANF) and a synchronization bit (SYN) are inserted as information into the binary frame (BR).

10. An apparatus for conversion of a bidirectional S₀ data stream for transmission via a low-voltage power network (NSN),
having a conversion unit (UE) for conversion of the pseudoternary S₀ data stream, which comprises a sequence of S₀ frames (SR) to a binary data stream which comprises a sequence of binary frames (BR),
having a protocol unit (PE) for insertion of the binary frames (BR) into a transmission packet which are intended for data transmission via the low-voltage power network (NSN), with the transmission packet being subdivided by means of a time division duplexing method (Time Division Duplex TDD) into a first area (DS-B) for data transmission of binary frames (BR) in a first transmission direction (DS), and into a second area (US-B) for data transmission of binary frames (BR) in a second transmission direction (US), and
having a transmission unit (UEE) for feeding the transmission packets into the low-voltage power network (NSN).

11. The apparatus as claimed in claim 10, characterized in that a master-slave communication relationship is set up for data transmission via the low-voltage power network (NSN).

12. The apparatus as claimed in claim 110,
characterized
in that a counter unit (ZE), which is associated with a respective in-house area (IHB) of the low-voltage power network (NSN), is in the form of a master device (M).

13. The apparatus as claimed in claim 12,
characterized
in that communication devices which are each connected via a connecting device (AE) to the in-house area (IHB) of the low-voltage power network (NSN) are in the form of slave devices (S1-S8).

14. The apparatus as claimed in claim 13,
characterized
in that a maximum of eight slave devices (S1-S8) can be connected to the low-voltage power network (NSN).

1. A method for conversion of a bidirectional S₀ data stream for transmission via a low-voltage power network (NSN),
in which the pseudoternary S₀ data stream, comprising a sequence of S₀ frames (SR), is converted to a binary data stream comprising a sequence of binary frames (BR), in which method a transmission packet which is intended for data transmission via the low-voltage power network (NSN) is subdivided, using a time division duplexing method, into a first area (DS-B) for data transmission in a first transmission direction (DS) and into a second area (US-B) for data transmission in a second transmission direction (US), and
in which method the binary frames (BR) are inserted into the first or into the second area (DS-B, US-B) of the transmission packet depending on the direction, and are passed to a transmission unit (UEE) for transmission via the low-voltage power network (NSN).

5. The method as claimed in one of the preceding claims,
characterized
in that the transmission packet are each subdivided into at least one subframe by means of a multiple access control method based on time division multiplexing,
and in that the binary frames (BR) are each inserted into a subframe in the first area (DS-B) or in the second area (US-B) of the transmission packet depending on the direction.

10. An apparatus for conversion of a bi-directional S₀ data stream for transmission via a low-voltage power network (NSN),
having a conversion unit (UE) for conversion of the pseudoternary S₀ data stream, which comprises a sequence of S₀ frames (SR) to a binary data stream which comprises a sequence of binary frames (BR),
having a protocol unit (PE) for insertion of the binary frames (BR) into a transmission packet which are intended for data transmission via the low-voltage power network (NSN), with the transmission packet being subdivided by means of a time division duplexing method into a first area (DS-B) for data transmission of binary frames (BR) in a first transmission direction (DS), and into a second area (US-B) for data transmission of binary frames (BR) in a second transmission direction (US), and
having a transmission, unit (UEE) for feeding the transmission packets into the low-voltage power network (NSN).
